(19) United States
(12) Patent Application Publication
(10) Pub. No.: US 2015/0056844 A1
(43) Pub. Date: Feb. 26, 2015

(54) Electric Connector

(71) Applicant: IRISO ELECTRONICS CO., LTD., Kanagawa (JP)

(72) Inventor: Toru Takane, Kanagawa (JP)

(73) Assignee: IRISO ELECTRONICS CO., LTD., Kanagawa (JP)

(21) Appl. No.: 14/458,497

(22) Filed: Aug. 13, 2014

(30) Foreign Application Priority Data
Aug. 21, 2013 (JP) 2013-171229

(51) Int. Cl. H01R 13/62; H01R 12/77

(52) U.S. Cl. CPC H01R 13/62; H01R 12/774
USPC 439/372

(57) ABSTRACT

An electric connector including a housing having an insertion opening for a flat conductor, a connector terminal that is conductively connected to the flat conductor, an actuator having a pressing surface, and a shaft portion. The connector terminal is provided with a terminal portion that comes in contact with the flat conductor and a base end that supports the terminal portion. The terminal portion is provided with a front terminal that includes a front contact portion that is provided on an insertion opening side with respect to the shaft portion so as to face the pressing surface and a rear terminal that includes a rear contact portion that is provided on the rear side of the housing with respect to the pressing surface and at a position that is closer to the pressing surface with respect to the front contact portion.

### BACKGROUND OF THE INVENTION

1. Field of the Invention

The present invention relates to an electric connector that conductively connects a flat conductor to a printed board.

2. Description of the Related Art

An electric connector such as a flexible printed circuit (FPC) or a flexible flat cable (FFC) that conductively connects a flat conductor and a printed board to each other is typically used. As such an electric connector, an electric connector is known that includes a plurality of terminals that have connection portions that come in contact with a flat conductor and that press the flat conductor against the terminals by pivoting an actuator (see Japanese Unexamined Patent Application Publication No. 2009-158279, for example).

The above electric connector includes front terminals that are positioned on the flat conductor insertion opening side with respect to the shaft portion of the actuator and rear terminals that are positioned on the rear side of the flat conductor with respect to the shaft portion of the actuator. Moreover, rear contact portions that are provided in the rear terminals are disposed above (on a pressing surface side of the actuator) front contact portions provided in the front terminals and the front contact portions and the rear contact portions are provided at positions facing the pressing surface of the actuator when the flat conductor is in a fitted state. In the above case, the pressing surface of the actuator is fixed so as to be inclined in the closing direction of the actuator along an inclination connecting the rear contact portions and the front contact portions. With the above configuration, the actuator is not easily pivoted in the opening direction and the flat conductor and the electric connector connected together are not easily released from each other.

However, in the electric connector described above in which the rear terminals are positioned on the rear side with respect to the shaft portion and in which the rear terminals are disposed at a position facing the pressing surface of the actuator, upon inclination of the pressing surface of the actuator in the closing direction, the flat conductor becomes inclined in the closing direction of the actuator in a similar manner. Furthermore, the rear terminals apply a force to the actuator in the closing direction such that the inclination in the closing direction of the actuator is strongly maintained. Accordingly, there are cases in which a portion of the flat conductor that is exposed to the outside of the electric connector comes in contact with the printed board causing unintended conductive connection, and thus disadvantageously requiring additional insulation measures to be implemented.

### SUMMARY OF THE INVENTION

The present invention has been made to overcome the above shortcomings. In other words, an object of the invention is to provide an electric connector that can, without exerting any pressing force that biases the actuator in the closing direction, make it difficult for the electric connector and the flat conductor fitted together to be released from each other.

In order to achieve the object described above, the present invention is configured as below.

That is to say, an electric connector is provided including a housing including an insertion opening for a flat conductor, a connector terminal that is conductively connected to the flat conductor, an actuator including a pressing surface that presses the flat conductor against the connector terminal by a pivoting motion, and a shaft portion that serves as a central axis of the pivoting motion. The connector terminal includes a terminal portion that comes in contact with the flat conductor and a base end that supports the terminal portion at a position on a rear side of the housing in a short direction. The terminal portion includes a front terminal that includes a front contact portion that is provided on an insertion opening side with respect to the shaft portion and at a position facing the pressing surface, and a rear terminal that includes a rear contact portion that is provided on the rear side of the housing in the short direction with respect to the pressing surface and at a position on the upper side of the housing with respect to the front contact portion.

Since the terminal portion includes the front terminal that has the front contact portion and the rear terminal that has the rear contact portion, even if, for example, there is a contact failure between one of the terminals and the flat conductor, the other terminal can be in contact with the flat conductor; accordingly, conductive connection can be established in a reliable manner. Furthermore, the displacement of the rear contact portion disposed on the rear side of the housing can be made large by providing the rear contact portion at a position on the upper side of the housing with respect to the front contact portion; accordingly, contact pressure of the rear terminal can be increased and contact with the flat conductor can be established in a reliable manner.

Furthermore, by providing the front contact portion that is positioned on the insert opening side with respect to the shaft portion at a position facing the pressing surface, the flat conductor can be pressed against the pressing surface and the flat conductor can be held between the front contact portion and the pressing surface. Moreover, since the rear contact portion is disposed on the rear side of the housing in the short direction with respect to the pressing surface, the contact pressure of the rear terminal does not directly act on the pressing surface of the flat conductor. Accordingly, the rear terminal can be in contact with the flat conductor in a reliable manner without the rear terminal, which is fitted with the flat conductor, directly applying a pressing force to the actuator in both the closing direction and the opening direction.

The rear terminal of the present invention may be connected to the base end at a position on the rear side of the housing in the short direction with respect to the insertion end of the flat conductor in the fitted state.

Accordingly, the length of the rear terminal can be set long and the displacement of the rear terminal in the direction in which the pressing surface presses the flat conductor can be increased. Accordingly, the contact pressure of the rear terminal can be increased and the connection reliability on the flat conductor can be improved.

The front terminal of the present invention may be connected to the base end at a position on the rear side of the housing in the short direction with respect to the insertion end of the flat conductor in the fitted state.

With such a configuration, since the length of the front terminal can be set long, the displacement of the front terminal in the direction in which the pressing surface presses the flat conductor can be increased. Accordingly, the contact pressure of the front terminal can be increased and the connection reliability on the flat conductor can be improved.

The rear terminal of the present invention may be connected to the base end at a position on the upper side of the housing with respect to the insertion end of the flat conductor in the fitted state.

When the rear terminal is, with respect to the insertion end of the flat conductor in the fitted state, connected to the base end at a position on the pressing surface side in the direction in which the pressing surface presses the flat conductor, the rear terminal that extends from the base end extends around to the side of the flat conductor opposite the pressing surface side and comes in contact with the flat conductor. Accordingly, the length of the rear terminal can be made long and the rear terminal can be one that is bent easily and that is not easily damaged.

The front terminal of the present invention may be inclined towards the pressing surface side from the base end side to the distal end side.

With such a configuration, a large space can be provided between the distal end side of the front terminal and the bottom portion of the housing; accordingly, a large space in which the front contact portion of the front terminal is displaced can be obtained. Accordingly, when the front terminal is pressed by the flat conductor, the front terminal can be displaced in a greater manner and the contact pressure can be increased, and thus, the contact reliability on the flat conductor can be improved. Furthermore, since a large space can be provided between the base end side of the front terminal and the base end side of the rear terminal as well, the rear terminal can be prevented from coming in contact with the front terminal when the rear terminal is displaced.

The contact pressure of the rear terminal of the present invention may be set higher than the contact pressure of the front terminal.

With such a configuration, the rear contact portion that is positioned on the rear side with respect to the front contact portion can be in contact with the flat conductor in a reliable manner. Furthermore, upon pivoting of the actuator, the flat conductor first comes in contact with the rear terminal and then comes in contact with the front terminal. If the contact pressure of the front terminal is higher than the contact pressure of the rear terminal, in order to displace the front terminal, the actuator needs to be pivoted with a stronger force compared to a case in which the rear terminal is displaced. Accordingly, an operator may feel a reactive force in the hands when the flat conductor comes in contact with the front terminal, which may make the operator erroneously perceive that the fitting process of the flat conductor has been completed and may make the operator stop the pivoting operation.

Therefore, the contact pressure of the rear terminal is set higher than the contact pressure of the front terminal so that the momentum of the pivoting actuator that has displaced the rear terminal displaces the front terminal; accordingly, fitting process of the flat conductor can be completed in a reliable manner.

The pressing surface of the present invention may be provided in parallel to the printed board on which the housing is mounted when the flat conductor is in the fitted state.

With such a configuration, since the flat conductor and the printed board can be maintained parallel to each other, a portion of the flat conductor that is exposed to the outside of the electric connector can be prevented from coming in contact with the printed board.

The terminal portion of the present invention may extend from a position on the rear side of the housing towards the insertion opening.

When a cantilever-shaped terminal portion is formed such that the base end thereof is provided on the insertion opening side and such that the front contact portion and the rear contact portion that are free ends are provided on the rear side of the housing, because each of the contact portions come in contact with the flat conductor at the rear side of the housing, each of the effective fitting lengths to the flat conductor (the fitting lengths from the insertion end of the flat conductor to the contact of the front contact portion and to the contact of the rear contact portion) becomes disadvantageously short.

In such a case, the pressing surface of the actuator and the terminal portion press only the insertion end side of the flat conductor; accordingly, there are cases in which the portion of the insertion opening side that is not pressed is bent by its own weight and is inclined towards the closing direction of the actuator such that the likelihood of the flat conductor coming in contact with the printed board is increased.

Accordingly, in the present invention, the base end of a cantilever-shaped terminal portion is provided on the rear side of the housing and each of the contacts are provided on the insertion opening side. Since the contacts come in contact with the flat conductor on the insertion opening side of the housing, the flat conductor is more less likely to incline in the closing direction of the actuator.

The pressing surface of the present invention may be provided so as to incline upward from the rear side of the housing in the short direction towards the insertion opening side when the flat conductor is in the fitted state.

With such a configuration, the flat conductor may be maintained at an inclined state from the rear side of the housing in the short direction towards the insertion opening side; accordingly, the flat conductor can be prevented from coming in contact with the printed board in a more reliable manner.

According to the present invention, the front contact portion and the rear contact portion can be conductively connected to the flat conductor in a reliable manner. In particular, by providing the rear contact portion closer to the pressing surface of the actuator with respect to the front contact portion, the contact pressure of the rear terminal can be increased. Moreover, since the contact pressure of the rear terminal does not directly act on the pressing surface of the actuator and since the actuator do not pivot in the opening direction or the closing direction, the rear terminal and the flat conductor can be maintained in a fitted state in a reliable manner.

### BRIEF DESCRIPTION OF THE DRAWINGS

FIG. 1 is a perspective view illustrating an electric connector of a first embodiment.

FIG. 2 is a cross-sectional view taken along a line II-II indicated by arrows in FIG. 1.

FIG. 3 is an explanatory drawing illustrating a state in which the conductor is inserted into a connector terminal that is in an open state.

FIG. 4 is an explanatory drawing illustrating a state in which an actuator is rotated from the state in FIG. 3 such that the flat conductor and a rear contact portion are in contact with each other.

FIG. 5 is an explanatory drawing illustrating a state in which the actuator is further rotated from the state in FIG. 4 such that the flat conductor and a front contact portion are in contact with each other.

FIG. 6 is an explanatory drawing illustrating a state in which the flat conductor is fitted to the electric connector of FIG. 1.

FIG. 7 is a cross-sectional view of an electric connector of another embodiment that corresponds to FIG. 2.

FIG. 8 is an explanatory drawing illustrating a state in which the flat conductor is fitted to the electric connector of FIG. 7.

### DESCRIPTION OF THE PREFERRED EMBODIMENTS

Hereinafter, preferred embodiments of the present invention will be described with reference to the drawings. Components that are common among each of the embodiments below will be denoted with the same reference numerals and repetitive description will be omitted.

### First Embodiment

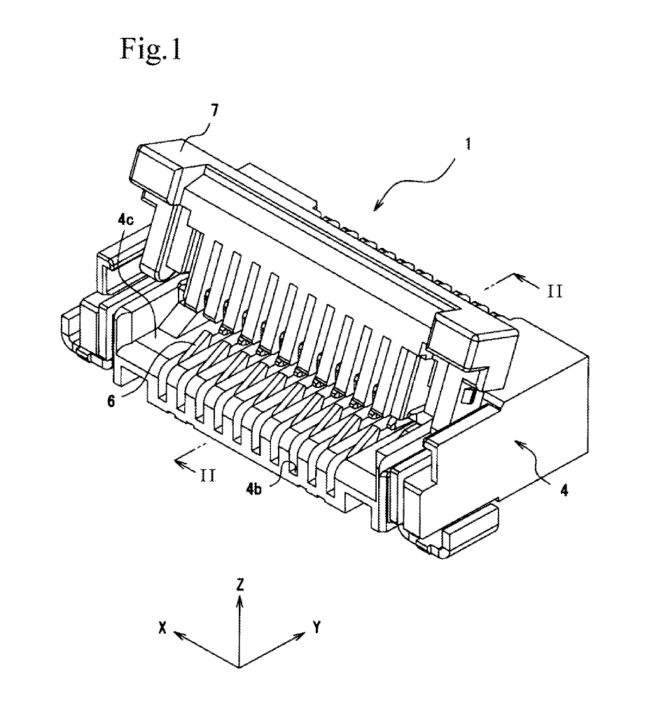

### FIGS. 1 to 6

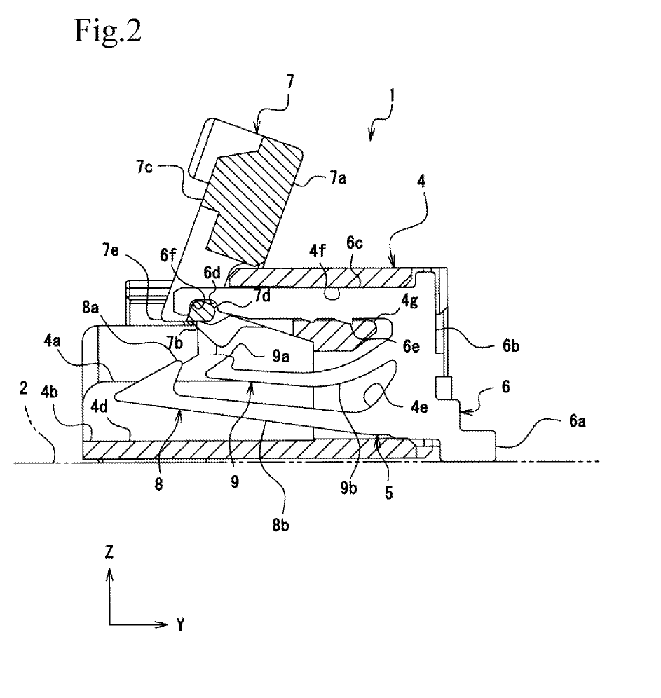

An electric connector 1 of the first embodiment according to the present invention is a connector that is mounted on the printed board 2 and that conductively connects a flat conductor 3, such as a flexible printed circuit (FPC) or a flexible flat cable (FFC), and a printed board 2 to each other. As illustrated in FIGS. 1 and 2, the electric connector 1 includes a housing 4 that receives the flat conductor 3 and terminal portions 5 that come in contact with the flat conductor 3. The electric connector 1 further includes a plurality of connector terminals 6 that are fixed to the housing 4 at equal intervals and an actuator 7 that is locked to the connector terminals 6 in a pivotal manner and that presses the flat conductor 3 against the connector terminals 6 upon pivoting of the actuator 7. Note that in the present specification, a description is given while the longitudinal direction of the electric connector 1 is referred to as an X direction, the short direction thereof is referred to as an Y direction, and a direction in which the actuator presses the flat conductor 3 is referred to as a Z direction.

### (Housing)

The housing 4 is composed of an insulating resin and is formed in a substantially rectangular parallelepiped shape. The housing 4 is provided with an insertion opening 4a into which the flat conductor 3 is inserted and a plurality of accommodation openings 4b in which the connector terminals 6 are accommodated. The plurality of accommodation openings 4b are provided at equal intervals in the X direction with respect to each other. Furthermore, a housing portion 4c that houses the actuator 7 when the actuator 7 is in a closed state is provided above the accommodation openings 4b.

### (Actuator)

The actuator 7 is composed of an insulating resin and is formed in a substantially rectangular parallelepiped shape. The actuator 7 includes an operation portion 7a that is operated when the actuator 7 is pivoted, a shaft portion 7b that is locked with respect to the connector terminals 6 in a pivotal manner, and a pressing surface 7c that is pressed against an upper surface 3a of the flat conductor 3 (a surface on the actuator 7 side). Furthermore, while the actuator 7 presses the flat conductor 3 against the terminal portions 5 by pivoting itself, the shaft portion 7b is positioned in the rear area of the pressing surface 7c.

### (Connector Terminal)

The connector terminals 6 are punched terminals that are formed by punching a flat conductive metal plate. Furthermore, the connector terminals 6 each include a substrate connecting portion 6a, a base end 6b, the terminal portion 5 and a fixing piece 6c.

The substrate connecting portions 6a are connected to the printed board 2.

The base ends 6b each have a substantially rectangular tabular shape and are provided adjacent to a corresponding substrate connecting portion 6a so as to extend in the Z direction.

The terminal portions 5 each extend towards the flat-conductor-3 insertion-opening-4a side from a corresponding base end 6b. The terminal portions 5 each include a front terminal 8 and a rear terminal 9 that come in contact with an undersurface 3b of the flat conductor 3 (a surface on the other side with respect to the upper surface 3a). Even if there is a contact failure between one of the terminals and the flat conductor 3, since two terminals, namely, the front terminal 8 and the rear terminal 9, are provided, the other terminal can come in contact with the flat conductor 3.

The fixing pieces 6c each extend in the Y direction from the upper end side (the side opposite to the printed board 2 in the Z direction) of a corresponding base end 6b and are fixed to the housing 4.

The front terminals 8 each include a front contact portion 8a that is provided on the distal end side thereof and that comes in contact with the undersurface 3b of the flat conductor 3 and an elastic portion 8b that elastically supports the front contact portion 8a. The front contact portions 8a are disposed on the insertion opening 4a side in the Y direction with respect to the shaft portion 7b of the actuator 7 and are provided so as to face the pressing surface 7c of the actuator 7. The elastic portions 8b each extend in a cantilevered manner from the printed board 2 side of a corresponding base end 6b in the Z direction and are provided so as to extend from the corresponding base end 6b side towards the distal end side in a free state while slightly inclining towards the pressing surface 7c side. Therefore, a large space may be secured between the front terminals 8 and a bottom wall 4d provided on the printed board 2 side of the housing 4 and, accordingly, the front terminals 8 can be elastically displaced in the Z direction in a greater manner and the contact pressure can be increased such that the front terminals 8 can be made to come in contact with the undersurface 3b of the flat conductor 3 in a reliable manner. Moreover, in the base end 6b side, since a space 4e can be provided between the front terminals 8 and the rear terminals 9, the rear terminals 9 can be made to move into and be elastically displaced in the spaces 4e.

As illustrated in FIG. 2, the rear terminals 9 are provided on the distal end side and come in contact with the undersurface 3b of the flat conductor 3. The rear terminals 9 each include a rear contact portion 9a and an elastic portion 9b that elastically supports the rear contact portion 9a.

The rear contact portions 9a are positioned closer to the pressing surface 7c with respect to the front contact portions 8a. Accordingly, the displacement of each of the rear contact portions 9a can be large such that the contact pressure of each of the rear terminals 9 is increased allowing each of the rear terminals 9 to come in contact with the flat conductor 3 in a reliable manner. Furthermore, the rear contact portions 9a are disposed on the insertion opening 4a side with respect to the shaft portion 7b and on the rear side with respect to the pressing surface 7c of the actuator 7.

The elastic portions 9b each extend in a cantilevered manner from a substantially middle portion of the corresponding base end 6b in the Z direction and from a position that is on the pressing surface side in the Z direction with respect to the position of an insertion end 3c of the flat conductor 3 in a fitted state. Furthermore, the elastic portions 9b extend around so as to avoid the flat conductor 3 in the fitted state towards a bottom wall 4d side from the portion where the elastic portions 9b are each connected to the corresponding base end 6b; in such a state, the rear contact portions 9a each come in contact with the undersurface 3b. With the above, the length of each of the elastic portions 9b can be made long; accordingly, the rear terminals 9 can be bent easily resulting in rear terminals 9 that are not easily damaged.

The rear contact portions 9a are disposed on the rear side in the Y direction with respect to the shaft portion 7b and on the rear side with respect to the pressing surface 7c of the actuator 7. The rear contact portions 9a are provided on the pressing surface 7c side with respect to the front contact portions 8a; accordingly, the displacement of each rear terminal 9 can be large. Accordingly, the contact pressure may be increased and the rear contact portions 9a can be made to come in contact with the flat conductor 3 in a reliable manner.

Furthermore, the front terminals 8 and the rear terminals 9 are each connected to the corresponding base end 6b at a portion on the rear side of the housing 4 with respect to the insertion end 3c of the flat conductor 3 in the fitted state. Accordingly, the lengths of the elastic portions 8b and 9b can be long and the displacement of the front terminals 8 and the rear terminals 9 can be large; accordingly, the contact pressures of the front terminals 8 and the rear terminals 9 can be increased and the front terminals 8 and the rear terminals 9 can be made to come in contact with the undersurface 3b of the flat conductor 3 in a reliable manner.

The fixing pieces 6c each include, at the distal end side thereof, a bearing concavity 6d, which locks the shaft portion 7b of the actuator 7. Furthermore, the fixing pieces 6c are each press-fitted into and fixed to a press-fit hole 4f of the housing 4. The fixing pieces 6c each include a lock portion 6e that is provided with concavities and convexities on the printed board 2 side. The lock portions 6e are engaged with inner walls of the press-fit holes 4f; accordingly, the fixing pieces 6c are fixed.

### (Method of Applying the Electric Connector)

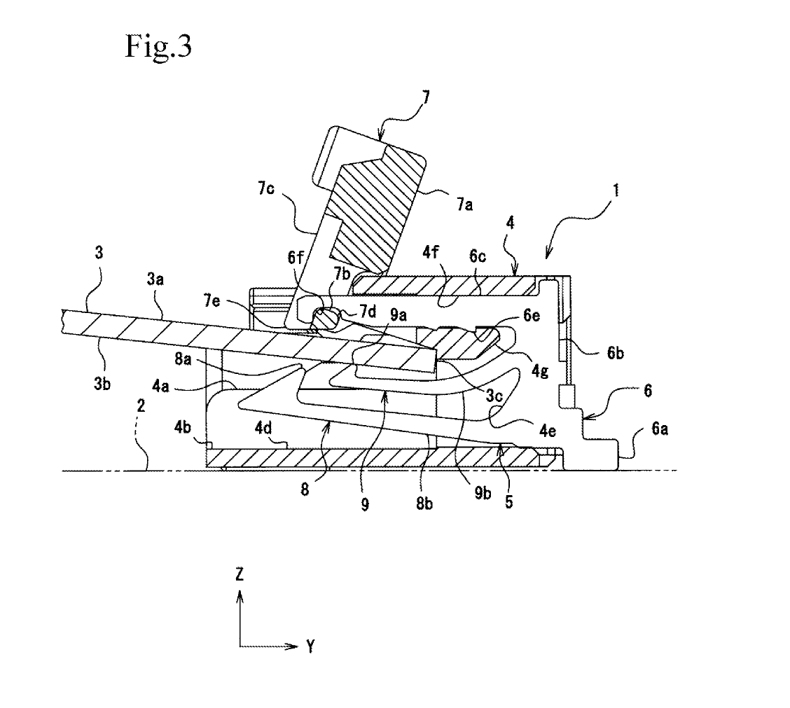

A method of applying the electric connector 1 according to the present embodiment will be described now. FIG. 3 illustrates an example in which the flat conductor 3 is in contact with the rear contact portions 9a before the front contact portions 8a and in which the front contact portions 8a are not in contact with the flat conductor 3. However, the flat conductor 3 may softly come in contact with the front contact portions 8a before the rear contact portions 9a or may softly come in contact with the rear contact portions 9a at the same time with the front contact portions 8a.

As illustrated in FIG. 3, first, the flat conductor 3 is inserted inside the housing 4 from the insertion opening 4a and is abutted against a conductor receiving portion 4g that is provided in the accommodation openings 4b. The conductor receiving portion 4g functions as a stopper that stops the flat conductor 3 from being inserted into the rear side in the Y direction with respect to a predetermined position.

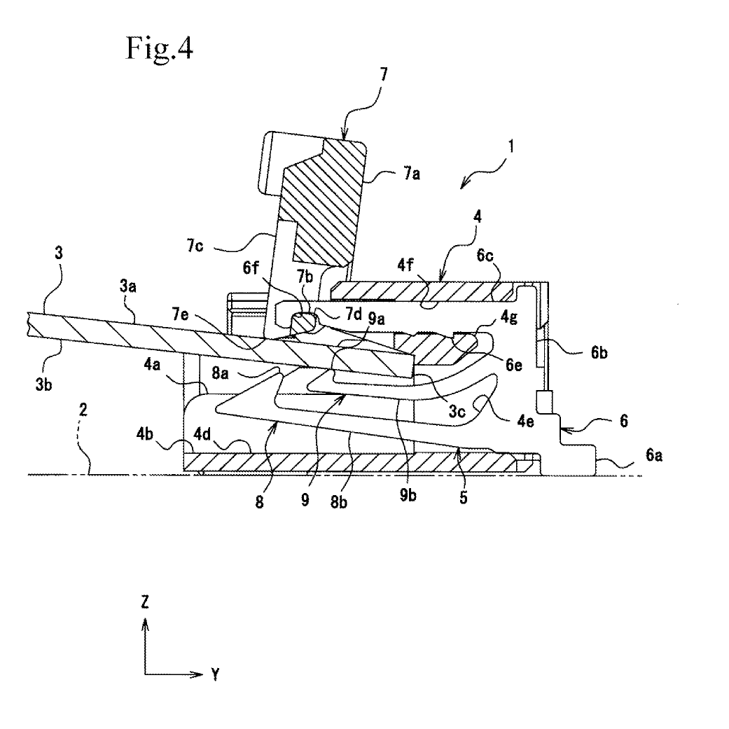

Furthermore, as illustrated in FIG. 4, when the actuator 7 that is in an open state is pivoted about the shaft portion 7b serving as a rotating shaft, pressing protrusions 7e that are provided so as to protrude out at an acute angle on the shaft portion 7b side of the actuator 7 are pressed against the upper surface 3a of the flat conductor 3. Moreover, at the same time, the rear contact portions 9a are pressed by the undersurface 3b of the flat conductor 3 and are displaced downwardly. At this time, since the flat conductor 3 is not in contact or is only softly in contact with the front contact portions 8a, the actuator 7 can be pivoted in the closing direction with a light force.

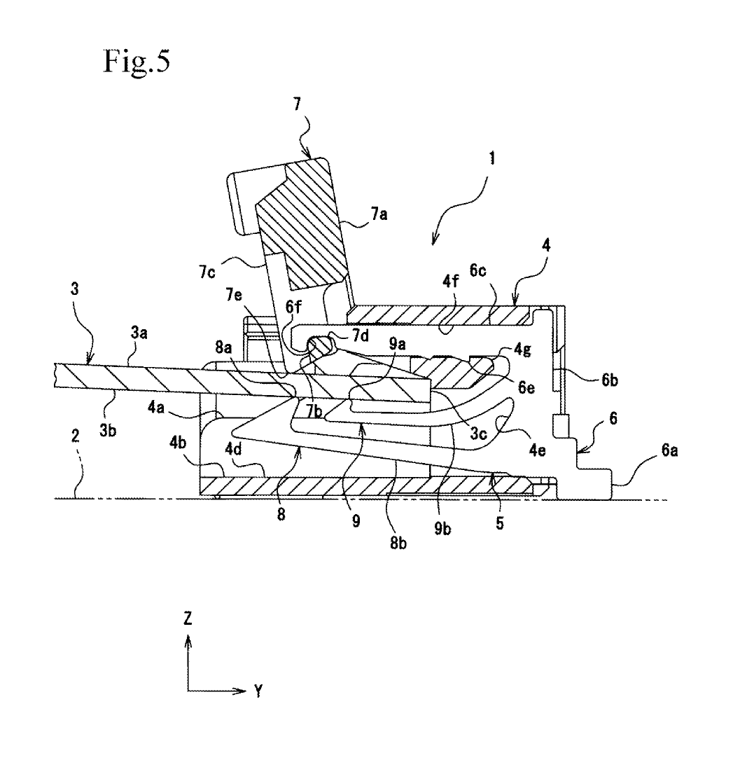

After that, when the actuator 7 is further pivoted, as illustrated in FIG. 5, the undersurface 3b of the flat conductor 3 comes into contact with the front contact portions 8a and displaces the front contact portions 8a downwards. At this stage, since the actuator 7 is inclined forward to the insertion opening 4a side, the actuator 7 can be pushed down easily in the closing direction with a light force.

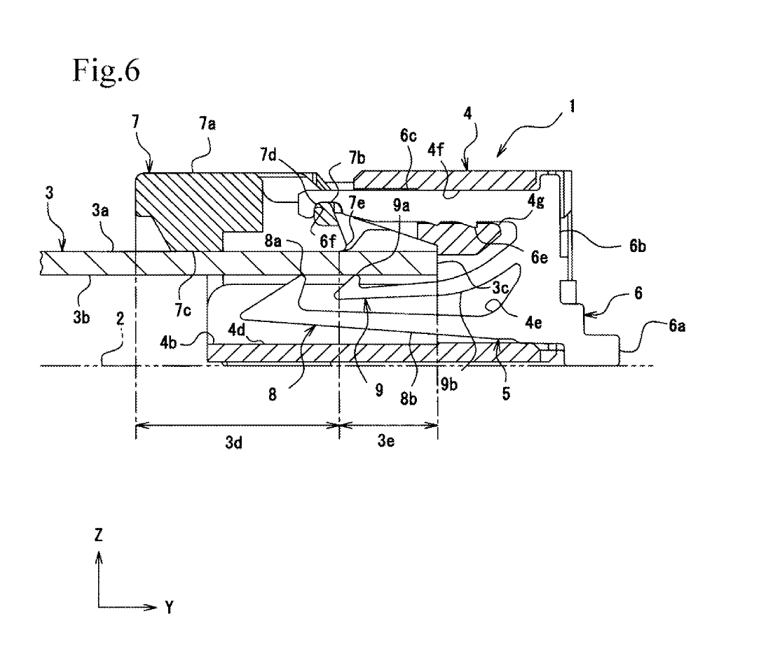

When the actuator 7 is further pivoted, as illustrated in FIG. 6, the pressing protrusions 7e that are positioned on the insertion opening 4a side with respect to the shaft portion 7b are instantaneously moved over the upper surface 3a of the flat conductor 3 while pressing the upper surface 3a of the flat conductor 3 towards the undersurface 3b side with the momentum of the pivoting actuator 7. With the above, the pressing protrusions 7e are moved to the rear side with respect to the shaft portion 7b. In the above manner, the pressing surface 7c of the actuator 7 becomes parallel to the printed board 2, and the fitting process is completed.

In the above fitted state, since the pressing protrusions 7e that are on the rear side with respect to the shaft portion 7b moves to the insertion opening 4a side, the pressing protrusions 7e need to press the upper surface 3a in the undersurface 3b direction and move over the upper surface 3a. Accordingly, even if there is pressure applied to the actuator 7 or the flat conductor 3 in the opening direction, pivoting of the actuator 7 can be suppressed and the fitted flat conductor 3 and electric connector 1 can be prevented from being detached.

The front contact portions 8a are disposed so as to face the pressing surface 7c of the flat conductor 3 in the fitted state and hold a press receiving portion 3d of the flat conductor 3, which is in contact with the pressing surface 7c, between themselves and the pressing surface 7c such that the printed board 2 is maintained in a parallel state.

Conversely, the rear contact portions 9a are disposed on the rear side with respect to the press receiving portion 3d and are in contact from the lower side with a non-press-receiving portion 3e of the flat conductor 3 that does not come in contact with the pressing surface 7c. Accordingly, since the pressing surface 7c of the actuator 7 does not directly receive the pressing force of the rear terminals 9, the actuator 7 can be prevented from being pivoted in both the closing direction and the opening direction.

Furthermore, in the electric connector 1 of the present embodiment, the base ends of the elastic portions 8b and 9b are provided on the rear side of the housing 4 and the front contact portions 8a and the rear contact portions 9a are provided on the insertion opening 4a side. Accordingly, the flat conductor 3 can be brought in contact on the insertion opening 4a side of the housing 4 and, as a result, the flat conductor 3 can be further prevented from easily tilting in the closing direction of the actuator 7.

The contact pressures of the rear terminals 9 are set higher than the contact pressures of the front terminals 8. If the contact pressures of the front terminals 8 are set higher than the contact pressures of the rear terminals 9, the operator may feel a stronger reactive force in the hands when the actuator 7 is pivoted and when the undersurface 3b of the flat conductor 3 comes in contact with the front terminals 8 after the rear terminals 9 are displaced. Then, the operator may erroneously perceive that the fitting process has been completed and may stop the fitting work.

Therefore, in the electric connector 1 of the present embodiment, the contact pressures of the rear terminals 9 are set higher than the contact pressures of the front terminals 8. By doing so, the front terminals 8 can be displaced instantaneously with the momentum created by pivoting the actuator 7 and by displacing the rear terminals 9. Accordingly, the undersurface 3b of the flat conductor 3 can be reliably brought in contact with the front terminals 8 and the rear terminals 9.

The section of the shaft portion 7b does not have a circular shape but has a substantially trapezoid shape and an edge portion 7d is formed so as to have a rounded shape. Furthermore, the bearing concavity 6d is also formed in a substantially trapezoid and rounded shape so as to correspond to the sectional shape of the shaft portion 7b. Accordingly, during pivoting of the actuator 7, the pivoting of the actuator 7 is stopped when a state in which the edge portion 7d of the shaft portion 7b matches the edge portion 6f of the bearing concavity 6d is reached. With the above, the pivoting of the actuator 7 in the closing direction can be suppressed in a further reliable manner and a state in which the flat conductor 3 is parallel to the printed board 2 can be maintained.

As described above, the electric connector 1 and the connector terminals 6 according to the present embodiment can, without exerting any pressing force that biases the actuator 7 in the closing direction, make it difficult for the flat conductor 3 that is fitted into the electric connector 1 to be released from the electric connector 1.

### Modification of the First Embodiment

The electric connector 1 of the first embodiment illustrates an example in which the pressing surface 7c of the actuator 7 is fixed in a parallel manner to the printed board 2. Conversely, the second embodiment may be an electric connector 10 in which the pressing surface 7c is not parallel to the printed board 2 but is inclined upwards from the rear side of the housing 4 towards the insertion opening 4a side. With such a configuration, the flat conductor 3 can be inclined upwards in a similar manner from the rear side of the housing 4 to the insertion opening 4a side; accordingly, the flat conductor 3 can be prevented from coming in contact with the printed board 2 in a more reliable manner.

### Other Embodiments

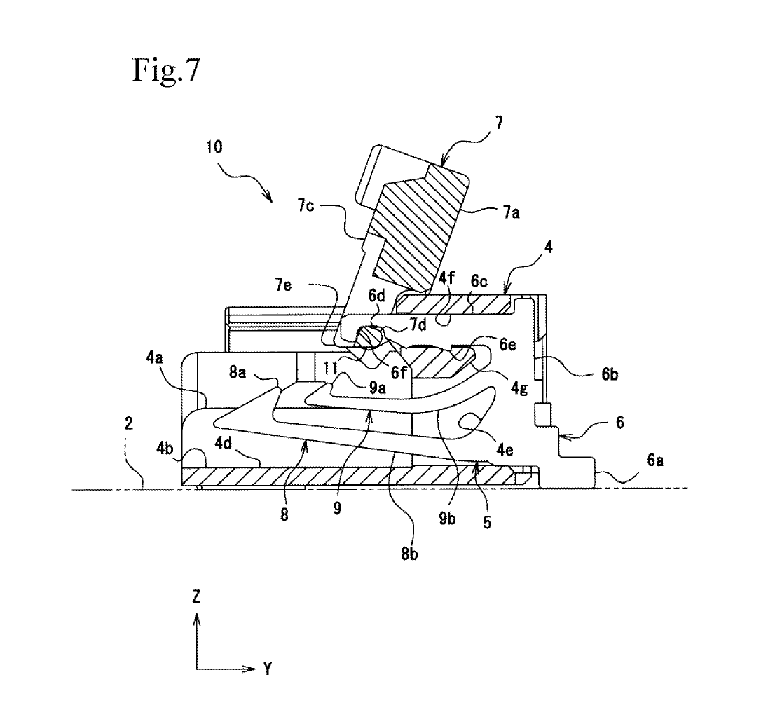

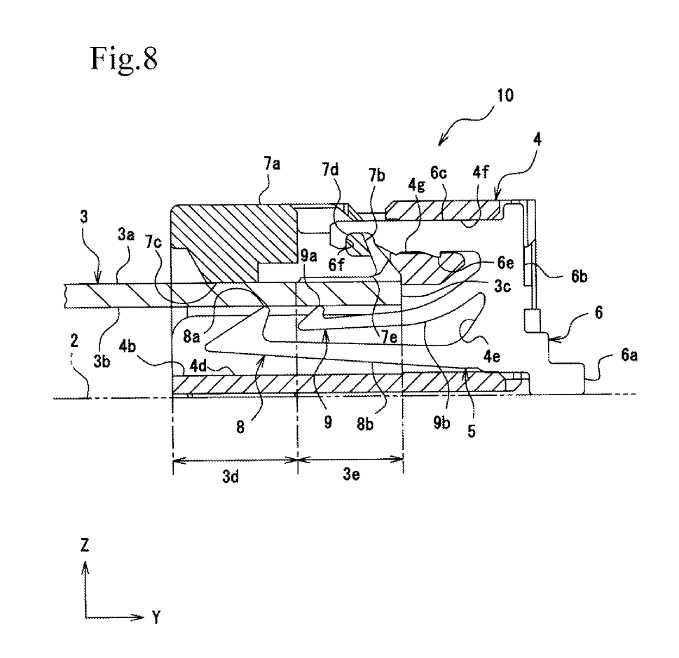

### FIGS. 7 and 8

The first embodiment illustrates an example in which the shaft portion 7b of the actuator 7 is provided in the area of the pressing surface 7c and in which the rear terminals 9 are provided on the rear side of the housing 4 with respect to the shaft portion 7b of the actuator 7. However, as illustrated in FIGS. 7 and 8, the electric connector may be an electric connector 10 in which a shaft portion 11 is provided on the rear side with respect to the pressing surface 7c. By providing the shaft portion 7b in such a manner as in the above case, the distal end side of the actuator 7 can be prevented from extending out on the insertion opening 4a side in the Y direction. With such a configuration, the electric connector 10 that is compact in the Y direction can be fabricated. Furthermore, in the electric connector 10, the rear terminals 9 may be disposed on the insertion opening 4a side with respect to the shaft portion 11. With such a configuration, the actuator 7 can maintain the fitting state with the flat conductor 3 without receiving any pressing force from the rear terminals 9 in both the closing direction and the opening direction.

What is claimed is:

1. An electric connector, comprising:
a housing including an insertion opening for a flat conductor;
a connector terminal that is conductively connected to the flat conductor;
an actuator including a pressing surface that presses the flat conductor against the connector terminal by a pivoting motion and a shaft portion that serves as a central axis of the pivoting motion, wherein
the connector terminal includes
a terminal portion that comes in contact with the flat conductor, and
a base end that supports the terminal portion at a position on a rear side of the housing in a short direction,
the terminal portion includes
a front terminal that includes a front contact portion that is provided on an insertion opening side with respect to the shaft portion and at a position facing the pressing surface, and
a rear terminal that includes a rear contact portion that is provided on the rear side of the housing in the short direction with respect to the pressing surface and at a position on the upper side of the housing with respect to the front contact portion, and
the rear terminal is connected to the base end at a position on the upper side of the housing with respect to an insertion end of the flat conductor in a fitted state.

2. The electric connector according to claim 1, wherein
the rear terminal is connected to the base end at a position on the rear side of the housing in the short direction with respect to the insertion end of the flat conductor in the fitted state.

3. The electric connector according to claim 1, wherein
the front terminal is connected to the base end at a position on the rear side of the housing in the short direction with respect to the insertion end of the flat conductor in the fitted state.

4. The electric connector according to claim 1, wherein
the front terminal is inclined from the base end side towards a distal end side so as to approach the pressing surface.

5. The electric connector according to claim 1, wherein
the pressing surface is provided in a parallel manner with respect to a printed board on which the housing is mounted when the flat conductor is in the fitted state.

6. The electric connector according to claim 1, wherein
the pressing surface is provided so as to incline upward from the rear side of the housing in the short direction towards the insertion opening side when the flat conductor is in the fitted state.

7. The electric connector according to claim 1, wherein
the shaft portion is provided on the rear side of the housing in the short direction with respect to the pressing surface.
